(19) United States
(12) Patent Application Publication
(10) Pub. No.: US 2008/0012686 A1
(43) Pub. Date: Jan. 17, 2008

(54) Padlock using user's fingerprint as its key

(76) Inventor: Terry L. Bonestroo, Hull, IA (US)

Correspondence Address: SUNG I. OH, PROFESSIONAL LAW CORPORATION, 710 QUAIL VALLEY LANE, WEST COVINA, CA, 91791, US

(21) Appl. No.: 11/481,989

(22) Filed: Jul. 6, 2006

(51) Int. Cl. G06K 9/00

(52) U.S. Cl. 340/5.53; 340/5.73; 382/124; 70/38 A; 70/20

(57) ABSTRACT

A lock is in the form of a padlock, but is operated according to the fingerprint or thumbprint of a user. The lock has circuitry in the case which is connected to the shackle to open the lock when the user places his or her finger or thumb onto a pad on the case.

### TECHNICAL FIELD OF THE INVENTION

The present invention relates to the general art of locks, and to the particular field of locks with special features.

### BACKGROUND OF THE INVENTION

The use of locking systems and safe boxes for storing and locking items for the purpose of preventing unauthorized access and use is generally known. Such systems are useful for limiting access to stored items in private and commercial or public settings. In private residential settings, for example, it is desirable to prevent unauthorized access to and use of handguns by children, intruders, or other unauthorized individuals. In commercial or public settings, it is desirable to prevent unauthorized access to and use of stored items, such as handguns, or the like in situations where the stored items are subject to theft or are inadvertently misplaced.

Some known systems use purely mechanical locks that comprise cumbersome mechanical components and the use of a key, a combination dial, or similar means. Such mechanical locks require time to manipulate a key or enter a combination. This is undesirable in situations where it may be necessary to quickly access and utilize a handgun. The mechanical components are subject to wear and failure. Keys and combinations can be obtained by unauthorized individuals. These drawbacks and others make the use of mechanical locks undesirable.

Other systems utilize electronic code-entry systems for electromechanical locking means. For example, some systems require that a code be keyed in on a keypad. These systems are subject to the same drawbacks as mechanical systems where codes can be accessed and used by unauthorized personnel or entry and access is undesirably delayed due to the time to key in the code. Access may be altogether prevented where a user cannot remember the access code.

Therefore, there is a need for a lock that can be easily set and manipulated, but does not have the drawbacks associated with combination or key locks.

### SUMMARY OF THE INVENTION

The above-discussed disadvantages of the prior art are overcome by a lock that is in the form of a padlock, but is operated according to the thumbprint or fingerprint of a user. The lock has circuitry in the case which is connected to the shackle to open the lock when the user places his or her thumb onto a pad on the case.

Using the lock embodying the present invention will permit a user to have all of the advantages associated with a padlock, but without having to remember a combination or a key. The lock is personalized to the specific user so no one else can open the lock by stealing a key or the combination.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a lock embodying the present invention.

FIG. 2 is a detail view of the bottom of the lock shown in FIG. 1.

### DETAILED DESCRIPTION OF THE INVENTION

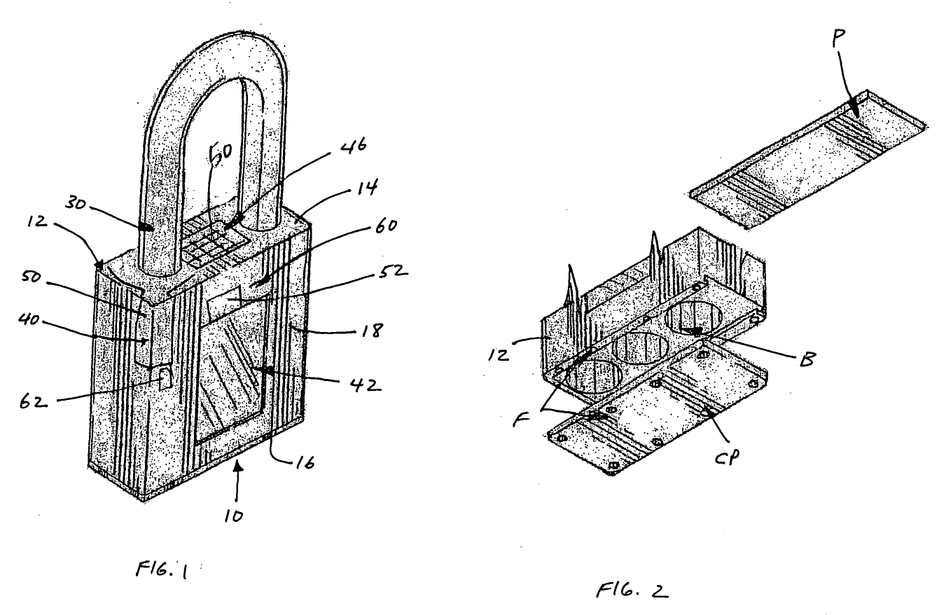

Referring to the figures, it can be understood that the present invention is embodied in a lock 10. Lock 10 comprises a case 12 which has a first end 14 which is a top end when the case is in use, a second end 16 which is a bottom end when the case is in use, a first face 18 and a second face 20. Lock 10 is shown in the form of a padlock. A shackle 30 is operatively connected to the case to move between a locked condition shown in FIG. 1 and an open condition with at least one portion of the shackle separated from the case.

Lock 10 includes a shackle control circuit 40 in the case. Circuit 40 includes a translucent panel 42 on first face 18 of the case. Circuit 40 further includes a power source 46 in the case. The power source can be either a rechargeable battery or a solar cell 50 or a combination thereof. As taught in FIG. 2, the power source can include a plurality of batteries B and a separator panel P. A cover plate CP closes the battery compartment and is held on the case by fasteners F.

A circuit 50 is located in the case and is operatively connected to the shackle. Circuit 50 includes a first circuit portion 52 connected to the shackle to hold the shackle in the locked position and to release the shackle from the locked condition when circuit portion 52 is activated. A second circuit portion 60 is located adjacent to translucent panel to be exposed to a fingerprint or thumbprint when a finger or thumb is placed on the translucent panel. Second circuit portion 60 is electrically connected to the power source and to the first circuit portion and acts like a switch to connect the first circuit portion to the power source when a selected print is exposed to the first circuit portion to activate the first circuit portion.

Circuit 40 further includes a memory portion 62 which stores registered thumbprint or fingerprint data. It is noted that fingerprint matching systems that detect fingerprints and compare them with fingerprint data in a stored database have been available in the prior art for some time now, see for example the system disclosed in U.S. Pat. No. 6,912,299, the disclosure of which is incorporated herein by reference. Those skilled in the art will thus understand the details of the circuit required to carry out the functions and operations described herein. These circuit details, such as the light sources and projectors required, the optical filters, and the like are not important to the present invention and, as such, will not be described or claimed.

Use of the lock can be understood from the teaching of the foregoing disclosure. A user simply sets the circuit to be activated by his thumbprint or his fingerprint using the memory portion of the circuit, and only his print. The user then opens the shackle, places the lock on the item to be secured, and closes the shackle. The circuit locks the shackle in the locked condition. To open the lock, the user simply places his thumb or finger on the translucent panel and the circuit senses the thumbprint or fingerprint. The print reader reads a print from the thumb or finger, and a print verifier verifies the read print by comparing it with registered print data. If the thumbprint or fingerprint verification authenticates the person, the lock is electrically unlocked by the circuit activating and releasing the shackle from the locked condition to open the lock.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A lock comprising:
A) a case having
(1) a first end which is a top end when the case is in use,
(2) a second end which is a bottom end when the case is in use,
(3) a first face, and
(4) a second face;
B) a shackle operatively connected to the case to move between a locked condition and an open condition; and
C) a shackle control circuit in the case and including
(1) a translucent panel on the first face of the case,
(2) a power source in the case, and
(3) a circuit in the case operatively connected to the shackle and including
(a) a first circuit portion connected to the shackle to hold the shackle in the locked position and to release the shackle from the locked condition when the first circuit portion is activated, and
(b) a second circuit portion which is located adjacent to translucent panel to be exposed to a print when a thumb or finger is placed on the translucent panel, the second circuit portion being electrically connected to the power source and to the first circuit portion and acting like a switch to connect the first circuit portion to the power source when a selected print is exposed to the first circuit portion to activate the first circuit portion, and
(c) memory portion for storing registered thumbprint or fingerprint data.

2. The lock defined in claim 1 wherein the power source includes a solar cell.

3. The lock defined in claim 1 wherein the power source includes a rechargeable battery.
